(19) United States
(12) Patent Application Publication
(10) Pub. No.: US 2009/0245202 A1
(43) Pub. Date: Oct. 1, 2009

(54) TUNNEL HANDOVER BETWEEN A WLAN AND A CELLULAR NETWORK

(76) Inventors: Laurence Gras, Nozay (FR); Yacine El Mghazli, Nozay (FR)

Correspondence Address: HARNESS, DICKEY & PIERCE, P.L.C., P.O. BOX 8910, RESTON, VA, 20195, US

(21) Appl. No.: 12/309,876

(22) PCT Filed: Aug. 9, 2007
(86) PCT No.: PCT/EP2007/058274

§ 371 Date: May 28, 2009

(30) Foreign Application Priority Data
Aug. 9, 2006 (FR) 0653326

(51) Int. Cl. H04W 36/00

(52) U.S. Cl. 370/331

(57) ABSTRACT

A method, dedicated to the management of the interworking between a wireless local area network and a mobile network, consists, in case of reception by an SGSN node (S1) of the mobile network of a routing area updating report sent by a mobile station (MS) during a transfer from the wireless local area network to the mobile network of a service session involving that mobile station (MS) and a tunnel termination gateway (TTG) and a GGSN node (NG) of the mobile network, via tunnels, i) to determine the address of a proxy SGSN node (S2) of the mobile network from the routing area identifier contained in the request in order to send that node (S2) a message requesting the transfer SGSN context of the mobile station (MS), ii) to recover from a home location register (HLR) of the mobile network, by means of the proxy SGSN node (S2), the address of the gateway (TTG) to send it a message requesting the transfer SGSN context of the mobile station, and iii) on receipt of the transfer SGSN context by the proxy SGSN node (S2), to transfer it to the SGSN node (S1) in order to effect a service PDP context update procedure intended to eliminate and/or modify the tunnels that have been established and to establish new tunnels between the mobile station (MS) and the GGSN node (NG), via the SGSN node (S1), to assure continuity of service during the session transfer.

The invention relates to interworking between wireless local area networks (WLAN) and 3GPP mobile communication networks, and more precisely to the transfer (handover) of communication sessions from the former networks (WLAN) to the latter networks (3GPP).

Here “wireless local area networks” means all communication local area networks having a WLAN radio interface enabling IP access (IEEE 802.11, Bluetooth and Hiperian/2 standards), and especially WiFi and WiMAX networks.

Here “3GPP networks” means all communication networks having a 3GPP radio interface enabling IP (Internet Protocol) access, and especially second Generation (2G) mobile (cellular) networks, for example GSM networks. 2.5G mobile (cellular) networks, for example GPRS/EDGE networks, and third generation (3G) mobile (cellular) networks, for example UMTS or CDMA2000 networks, together with all their variants.

Here “(3GPP/WLAN) interworking” means the possibility for a WLAN network to use certain 3GPP core network infrastructures to enable the user of a hybrid (3GPP/WLAN) mobile station, connected to that WLAN network, to access packet services offered by one or more Internet service providers (ISP). Such interworking is defined in particular by release 7 of the 3GPP Technical Specifications TS 23.234 and TS 23.934.

As the person skilled in the art knows, release 7 of the 3GPP/WLAN interworking standard (and more precisely its scenario N^{o} 4) provides continuity of service on handover of a communication session (involving a service) between a WLAN radio access network and a 3GPP radio access network. In other words, when a mobile station is using a service via a WLAN radio access network, it must be able to continue to use that service if it quits the WLAN radio access network to continue its call via a 3GPP radio access network.

A mobile station can use a service via a WLAN radio access network when end-to-end tunnels have been established between the mobile station and a tunnel termination gateway (TTG) of a 3GPP core network, on the one hand, and between that TTG gateway and a gateway GPRS support node (GGSN) providing the connection of the 3GPP core network to the IP network offering the service, on the other hand. Another architecture option establishes a tunnel between a mobile station and a PDG type equipment, but the invention does not apply to this.

A mobile station can use a service via a 3GPP radio access network only on condition that tunnels have been established, on the one hand, between that mobile station and a serving GPRS support node (SGSN) of the 3GPP core network and, on the other hand, between that SGSN node and the GGSN node providing the connection of the 3GPP core network to the IP network offering the service.

In a 3GPP network, the GGSN node is considered an anchor point including if a mobile station is moving from a WLAN network coverage area to that of a 3GPP (mobile) network. Consequently, during a handover (session transfer) from a WLAN network to a 3GPP network, the SGSN node that is contacted to continue the session must determine the identity of the TTG gateway used until then for said session, in order to obtain from the latter the transfer SGSN context, which includes the service PDP (Packet Data Protocol) context, and initiate a service PDP context transfer procedure (which context corresponds to the mobile station/GGSN node IP connection).

To achieve this objective, it has been proposed to modify the SGSN nodes so that, each time that they receive what the person skilled in the art refers to as a change of zone (routing area) report containing a specific WLAN routing area identifier (by default a mobile station uses the same RAI (Routing Area Identifier) value for all the WLANs), they can contact a location server called the home location register (HLR) to request from it the identifier of the TTG gateway with a view to initiating the context transfer. For an SGSN node to be able to contact the HLR to obtain the identifier and the IP address of a TTG gateway, its default behavior must be modified: in an inter-SGSN context it retrieves this information using an RAI relating to a particular coverage area and therefore a particular SGSN node through the intermediary of a domain name server (DNS).

This solution has two drawbacks: as indicated hereinabove, it necessitates modification of the mode of operation of the SGSN nodes, which is not very realistic given the large number of SGSN nodes already installed, and implies that each time an SGSN node receives a change of zone (routing area) report that triggers the transfer (handover) procedure, it performs a new test to verify if the RAI is valid (which signifies that the handover is of the inter-SGSN type and that it must execute the normal procedure with a DNS call) or not significant (which signifies that the handover is of the WLAN-3GPP type and that it must request the references of the TTG gateway from the HLR).

Thus an object of the invention is to propose a solution for maintaining continuity of service on transferring a communication session (involving a service) from a WLAN radio access network to a 3GPP radio access network that is free of some or all of the drawbacks cited above.

To this end the invention proposes a method dedicated to management of interworking between a wireless local area network (WLAN) and a 3GPP mobile network, and consisting in case of reception by an SGSN type node of said mobile network of a routing area updating report sent by a mobile station during an attempt to transfer from the wireless local area network to the mobile network a communication session relating to a service involving that mobile station and a tunnel termination gateway and a GGSN node of the mobile network, via end-to-end tunnels, in:

i) determining a communication identifier of a proxy SGSN node of the mobile network from the routing area identifier contained in the report so as to send that proxy SGSN node a message requesting the transfer SGSN context of tire mobile station,

ii) recovering from a home location register of the mobile network, by means of the proxy SGSN node, a communication identifier of the tunnel termination gateway so as to send it a message requesting said transfer SGSN context of the mobile station, and

iii) in case of reception of the transfer SGSN context by the proxy SGSN node, transferring that transfer SGSN context to the SGSN node so as to effect a service PDP context update procedure intended to eliminate and/or to modify the end-to-end tunnels established between the mobile station and the GGSN node, via the tunnel termination gateway, and to establish new tunnels between the mobile station and the GGSN node, via the SGSN node, to assure continuity of service during said communication session transfer.

This last phase in particular retains the IP address assigned to the service when it was set up (it is part of the PDP context) to keep the service open during the handover, as assigning a new IP address would lead to closing the service and then reopening it.

The method according to the invention can have other features, and in particular, separately or in combination:
in step iii) the SGSN node can send the GGSN node a service PDP context update request, and then send the home location register a message reporting that it is being substituted for the tunnel termination gateway, in order for it to instruct an AAA (Authentication, Authorization and Accounting) server of the mobile network to proceed to the elimination of the end-to-end tunnel between the mobile station and the tunnel termination gateway;
the SGSN node can for example generate the substitution report message on receipt of a substitution confirmation message coming from the GGSN node:
the communication identifiers can for example be IP addresses and/or ISDN identifiers;
in step iii) security operation can be effected before effecting the service PDP context update procedure;
in step iii) a GTP (GPRS Tunneling Protocol) end-to-end tunnel can be set up between the GGSN node and the SGSN node.

The invention also proposes an SGSN node, for a 3GPP mobile communication network, responsible, in case of reception of a routing area change report sent by a mobile station during an attempt to transfer from the wireless local area network to the mobile network a communication session relating to a service involving that mobile station and a tunnel termination gateway and a GGSN node of the mobile network, via end-to-end tunnels:

i) for determining a communication identifier of a proxy SGSN node of the mobile network from the routing area identifier contained in the report (default value, for all WLANs that send to the proxy SGSN node via a DNS server), then:

ii) sending the proxy SGSN node a message requesting a transfer SGSN context of the mobile station, and

iii) in case of reception of the transfer SGSN context, initiating a service

PDP context updating procedure intended to eliminate and/or to modify the end-to-end tunnels established between the mobile station and the GGSN node, via the tunnel termination gateway, and then to establish new tunnels between the mobile station and the GGSN node, via the SGSN node, to assure continuity of service during the communication session transfer.

This SGSN node can have other features and in particular, separately or in combination:
it can be responsible for sending the GGSN node a service PDP context update request, and then sending a home location register of the mobile network a message reporting that it is being substituted for the tunnel termination gateway, in order for it to instruct an AAA server of the mobile network to proceed to the elimination of end-to-end tunnels between the mobile station and the GGSN node, via the tunnel termination gateway;
it can be responsible for generating the substitution report message on receipt of a substitution confirmation message coming from the GGSN node;
it can be responsible for determining IP address and/or ISDN identifier type communication identifiers;
it can be responsible for effecting security operations with the mobile station and the GGSN node before effecting the service PDP context update procedure;

it can be responsible for establishing a GTP end-to-end tunnel with the GGSN node.

The invention also proposes a proxy SGSN node for a mobile communication network comprising processor means responsible, in case of receipt, from an SGSN node, of a message requesting a transfer SGSN context of a mobile station being transferred between a wireless local area network and the mobile network, of a communication session relating to a service, for recovering from a home location register of the mobile network a communication identifier of a tunnel termination gateway of the mobile network, involved in the session being transferred, and then, in case of reception of that communication identifier, for recovering from the tunnel termination gateway the transfer SGSN context requested in order to transfer it to the SGSN node.

Such processing means can for example be responsible for determining IP address and/or ISDN identifier type communication identifiers.

Other features and advantages of the invention will become apparent on reading the following detailed description and examining the appended drawings.

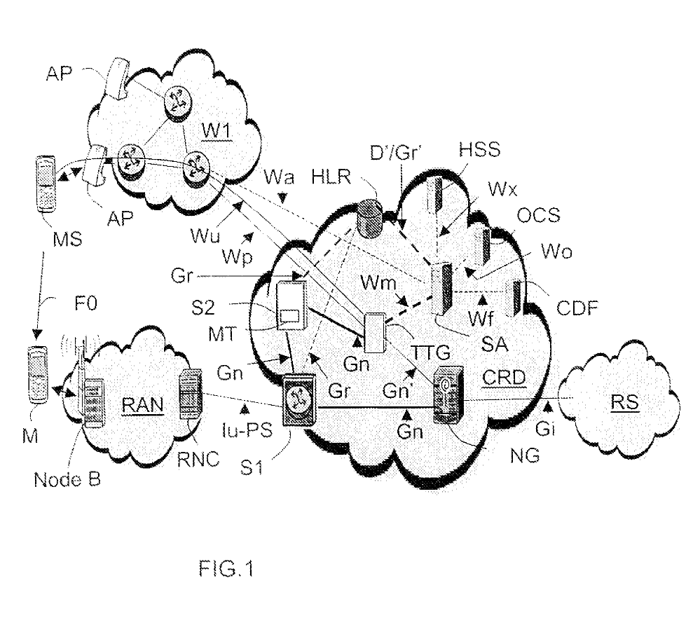

FIG. 1 is a highly diagrammatic and functional illustration of a 3GPP mobile network comprising a 3GPP radio access network and a 3GPP core network provided with a tunnel termination gateway connected to a WLAN radio access network, an SGSN node connected to the 3GPP radio access network, one embodiment of a proxy SGSN node of the invention, and a GGSN node connected to a service network.

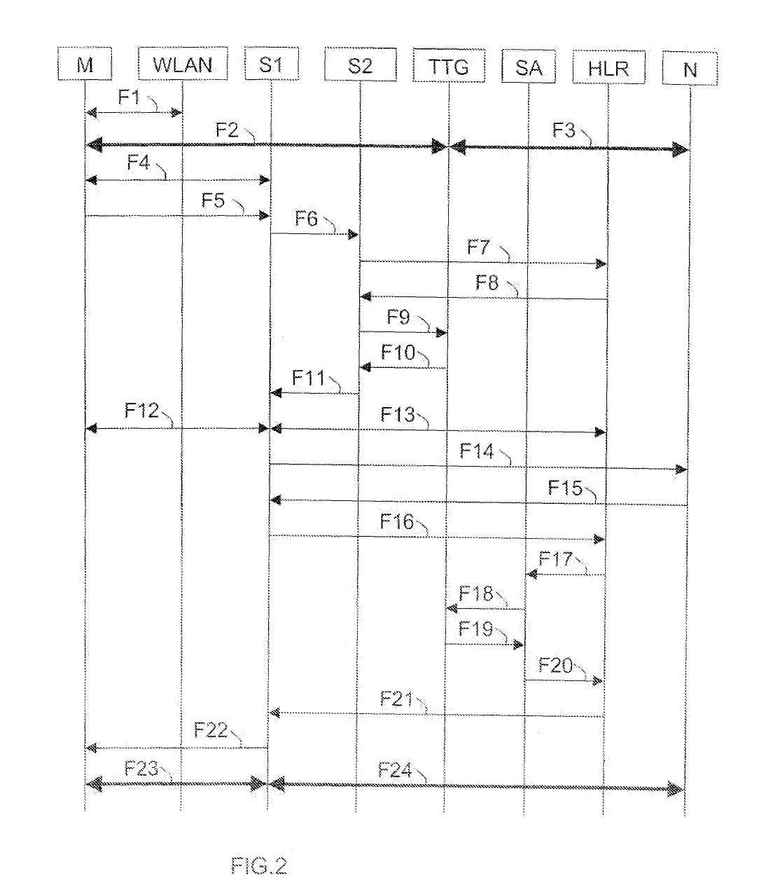

FIG. 2 is a diagrammatic illustration of the main steps of one example of a communication session transfer method of the invention used in the 3GPP mobile network illustrated in FIG. 1.

The appended drawings can constitute part of the description of the invention as well as contributing to the definition of the invention, if necessary.

An object of the invention is to maintain continuity of service on transferring a communication session (involving a service used by a mobile station) from a WLAN radio access network to a 3GPP radio access network.

It is considered hereinafter by way of nonlimiting and illustrative example that the 3GPP radio access network is part of a UMTS type 3GPP mobile (cellular) network. However, the invention is not limited to that type of mobile network. In fact it relates to all communication networks having a 3GPP radio interface enabling IP access and in particular 2G networks (for example GSM networks), 2.5G networks (for example CPRS/EDGE networks), and 3G networks (for example UMTS or CDMA2000 networks), together with all their variants and equivalents.

It is further considered hereinafter by way of nonlimiting and illustrative example that the WLAN radio access network is part of a wireless local area network (WLAN) of WiFi or WiMAX type. However, the invention is not limited to that type of WLAN network. In fact it relates to all wireless local area networks having a WLAN radio interface enabling IP access (IEEE 802.11. Bluetooth and Hiperian/2 standards).

The invention proposes a method dedicated to the management of interworking between a wireless local area network (WLAN) and a 3GPP mobile network. That method can be implemented by means of a network architecture of the type shown in FIG. 1 and comprising a 3GPP core network CRD, a network (set) of services (packet services) offered by one or more Internet service providers (ISP), at least one 3GPP radio access network RAN, and at least one WLAN radio access network W1 of a WLAN network.

It is considered hereinafter that the 3GPP radio access network RAN and the 3GPP core network CRD are part of the same UMTS network of which the users of the mobile stations MS are customers. Consequently, in the example described hereinafter the 3GPP core network CRD constitutes a home core network for the mobile stations MS. However, this is not obligatory.

It is important to note that the invention relates only to 3GPP/WLAN hybrid mobile stations MS. i.e. mobile stations having a communication card (for example a UICC card provided with a (U)SIM) enabling them to be connected both to WLAN radio access networks (WAN) and to 3GPP radio access networks (RAN). It can therefore be a question of any type of mobile communication equipment and in particular a mobile telephone, a portable computer or a personal digital assistant (PDA) equipped with a card of the type cited above.

The method of the invention must be used each time that a mobile station MS has set up a communication session with a network (set) or services RS through the intermediary of a WLAN radio access network W1 and at least its home core network CRD, in order to use a service, and the mobile station MS must be connected to a 3GPP radio access network RAN (where applicable a visited network) in order to continue the communication session used for said service.

The procedure for setting up the initial communication session via the WLAN radio access network W1 is well known to the person skilled in the art. For this reason it is not described in detail here. Suffice to say that a mobile station MS can be connected to the WLAN radio access network W1 via an access point AP. An access point AP is connected to the core network CRD either by at least one router of its WLAN network and a tunnel termination gateway TTG belonging to the 3GPP core network CRD via an interface called the Wp interface or directly to a gateway TTG via the Wp interface if that gateway TTG also implements the router function. The gateway TTG is connected, via an interface called the Gn′ interface, to a GGSN (Gateway GPRS Support Node) node GSN that is also part of the 3GPP core network CRD and serves as an access point, via an interface called the Gi interface, to one or more packet-switched (PS) services offered by at least one application server of a service network RS, for example. The gateway TTG has at least one communication identifier, for example an IP address, and where applicable an ISDN number (identifier).

When a communication session must be set up for a mobile station MS and for a given service, the station must first find the communication identifier (for example the IP address) of a gateway TTG. To this end the mobile station MS effects a domain name system (DNS) request (arrow F1 in FIG. 2). Then, once it has the IP address of the gateway TTG, the mobile station MS sends the gateway TTG, via an access point AP of the WLAN radio access network W1, an end-to-end tunnel establishment request (including in particular User-ID and W-APN fields), conforming to the 3GPP Technical Specification TS 23.234. This end-to-end tunnel is of the VPN/Ipsec type, for example. Once it has been established between the mobile station MS and the gateway TTG (arrow F2 in FIG. 2), via an interface called the Wu interface, the gateway TTG establishes, via the Gn′ interface, another end-to-end tunnel to the GGSN node NG that provides access to the service that is the subject of the requested session (arrow F3 in FIG. 2). This other end-to-end tunnel is of the GPRS tunneling protocol (GTP) type, for example.

Via an interface called the Gr′ interface, the gateway TTG sends a communication identifier of the mobile station MS and at least its own IP address, and generally its own ISDN number (identifier) to a home location register (HLR) of the core network CRD in order for it to store them in corresponding relationship to each other.

When the mobile station MS is getting ready to quit the WLAN radio access network W1 to be connected to the 3GPP radio access network RAN (arrow F0 in FIG. 1), it starts a communication session transfer (handover) procedure.

It is precisely at this stage that the method of the invention becomes operative.

An objective of the method is to enable a serving GPRS support node (SGSN) SN belonging to the 3GPP core network CRD and connected via an interface called the Gn interface to the GGSN node NG that provides access to the service that is the subject of the session transfer whereof is required to take over from the gateway TTG that is involved in this session.

In the case of a UMTS network the 3GPP radio access network RAN comprises base stations known as Node Bs and Radio Network Controllers (RNCs). An RNC is generally connected to at least one Node B and to the 3GPP core network CRD by one of its SGSN nodes via an interface called the Iu-PS interface. Each SGSN node has at least one communication identifier, for example an IP address, and possibly an ISDN number (identifier), and is connected to a GGSN node NG of the 3GPP core network CORD via a tunnel, preferably of the GPRS Tunneling Protocol (GTP) type, which uses an interface called the Gn interface.

When the mobile station MS (in session) quits the radio coverage area of the WLAN radio access network W1 and enters the radio coverage area of the 3GPP radio access network RAN, it sets up a UMTS connection to the SGSN node S1 that is connected to the GGSN node NG that provides access to the service that is the subject of the session via a Node B and the associated RNC (arrow F4 in FIG. 2). The mobile station MS then generates for sending to the SGSN node S1 a routing area (zone) updating report, for example of the “Routing Area Update Request” type. That report, which includes a default routing area identifier (RAI) that indicates its WLAN, is sent to the SGSN node S1 by the WLAN radio access network W1 (arrow F5 in FIG. 2).

When the SGSN node S1 receives the routing area update report, it must first determine a communication identifier of a proxy SGSN node S2 of the core network CRD.

The proxy SGSN node S2 is a new network equipment proposed by the invention. It is connected, firstly, to the SGSN node S1 via an interface called the Gn interface, secondly, to the gateway TTG, for example via another Gn interface, and, thirdly, to the home location register HLR, for example via an interface called the Gr interface. Just like the other SGSN node S1, the proxy SGSN node S2 has at least one communication identifier, for example an IP address, and possibly an ISDN number (identifier).

It will be noted that it is possible to install a plurality of proxy SGSN nodes in the same core network, for example for effecting load distribution, but this makes management of the default value of the RAI more complex. In this situation, it is possible to use a plurality of RAIs, for example, in order to distribute the load to a plurality of proxy SGSN nodes respectively associated with the various RAIs. In a variant, a DNS server capable of changing proxy SGSN node if the number of requests received reaches a selected level can be used.

Here “proxy SGSN node” means a network equipment that supports a subset of the functions supported by a standard SGSN node. In particular, such an equipment does not need an interface to the circuit-switched part of the network, which is dedicated to voice transport.

The default value of the RAI systematically refers the SGSN node S1 to the same proxy SGSN node S2. The SGSN node S1 that receives the update report interrogates a domain name server (DNS), for example, which has a list of IP addresses (communication identifiers) of proxy SGSN nodes stored in corresponding relationship to the default routing area identifier (RAI).

Once the SGSN node S1 has determined the communication identifier of the proxy SGSN node S2, it must determine the transfer SGSN context (the subject of the session to be transferred) used by the mobile station MS, in order to be able to substitute itself for the gateway TTG. For this purpose, it generates a message requesting the transfer SGSN context and then sends that message (arrow F6 in FIG. 2) to the proxy SGSN node S2 that is, according to the invention, responsible for recovering the transfer SGSN contexts relating to the sessions being transferred involving the gateways TTG to which it is connected (coupled). The request message contains information such as, in particular, the communication identifier of the mobile station MS. Remember that the home location register HLR stores this information in corresponding relationship to at least one communication identifier of the gateway TTG providing access to the service that is the subject of the session being transferred.

The transfer SGSN context that must be recovered contains the service PDP context and security elements specific to the mobile station MS concerned. The service PDP (Packet Data Protocol) context represents the definition of the current service. It includes the IP address of the GGSN node NG that serves as an access point to this service, and where applicable the ISDN number (identifier) of said GGSN node NG.

Moreover, the message requesting the transfer SGSN context is of the “SGSN Context Request( )” type, for example.

The transfer SGSN context must be recovered in two phases: a first in which at least one communication identifier of the gateway TTG to which the transfer relates must be recovered, and a second in which the transfer SGSN context is recovered from said gateway TTG.

The proxy SGSN node S2 includes, for example, a processor module MT responsible for recovering from the home location register HLR the transfer SGSN contexts relating to the gateways TTG. Consequently, if the proxy SGSN node S2 receives from the SGSN node S1 a message of the “SGSN Context Request( )” type, for example, its processor module M-T generates a request comprising the information necessary for recovering the transfer SGSN context of the mobile stations MS (for the session being transferred). This message is sent by the proxy SGSN node S2 to the home location register HLR via the interface Gr (arrow F7 in FIG. 2). This message is of the “Location Request( )” type, for example.

When the home location register HLR receives the Location Request( ) type message, for example, it searches its memory or database for the communication identifier (identifiers), for example the IP address, of the gateway TTG enabling execution of the session of the mobile station MS being transferred. The home location register HLR then generates a response message containing the call identifier(s) and sends it to the proxy SGSN node S2 via the interface Gr (arrow F8 in FIG. 2).

On receipt of the communication identifier(s), the processor module MT generates a new message requesting the transfer SGSN context of the mobile station MS that requested the transfer. This message (requesting the transfer SGSN context) is of the “SGSN Context Request( )” type, for example. The proxy SGSN node S2 then sends this SGSN Context Request( ) type message, for example, to the gateway TTG identified in the response message received, via the interface Gn (arrow F9 in FIG. 2).

In response to the received message, the gateway TTG generates a response message containing the required transfer SGSN context and sends it to the proxy SGSN node S2 via the interface Gn (arrow F10 in FIG. 2).

On receipt of this transfer SGSN context, the processor module MT inserts it into the response message that is sent to the SGSN node S1 via the interface Gn (arrow F11 in FIG. 2).

When the SGSN node S1 receives the response message, it can effect security operations with the mobile station MS and the GGSN node identified by the received message before effecting a procedure to update the service PDP context (arrows F12 and F13 in FIG. 2). These security operations consist in exchanging keys for making the exchanges secure, for example.

Once these security operations, if any, have been effected, the SGSN node effects a service PDP context update procedure intended to eliminate and/or modify the end-to-end tunnels (of VPN/IPSec and GTP type) set up between the mobile station MS and the GGSN node via the tunnel termination gateway TTG (arrows F2 and F3 in FIG. 2) to enable execution of the session being transferred.

For this purpose, it generates a service POP context update request, for example. This request is of the “Update PDP Context Request( )” type, for example. It is intended to inform the GGSN node NG that the SGSN node S1 is being substituted for the gateway TTG for the service session of the mobile station MS. It consequently includes the communication identifier(s) of the SGSN node S1, the identifier of the mobile station MS and other information linked to the latter. The SGSN node S1 sends the request to the GGSN node NG identified by the received transfer SGSN context via the interface Gn (arrow F14 in FIG. 2).

On receipt of this request, the GGSN node NG stores the information that it contains and then sends the SGSN node S1 an acknowledgement message (arrow F15 in FIG. 2). It is important to note that this updating of the service PDP context does not actually eliminate the GTP tunnel associated with the session being transferred, but modifies it. In fact, the effect of this is merely to replace its gateway TTG end with another SGSN node end, the IP address of the service remaining the same.

On receipt of this acknowledgement message, the SGSN node S1 must then update the home location register HLR. For this purpose, it generates a message reporting the substitution of the access point of the mobile station MS for the session being transferred, for example. This message is of the “Update Location( )” type, for example. It consequently includes the communication identifier(s) of the SGSN node S1 and the identifier of the mobile station MS. The SGSN node S1 sends the message to the home location register HLR via the interface Gr (arrow F16 in FIG. 2).

On receipt of this message, the home location register HLR updates its memory or database with the information that it contains and then sends an AAA server SA of the mobile network a message requesting elimination of the end-to-end (VPN/IPSec) tunnel between the mobile station MS and the tunnel termination gateway TTG via an interface D′/Gr′ (arrow F17 in FIG. 2). This message is of the “Cancel Location( )” type, for example. Consequently it includes the communication identifier(s) of the SGSN node S1, the identifier of the mobile station MS, the communication identifier(s) of the gateway TTG that must be replaced by that or those of the SGSN node S1 in corresponding relationship to the identifier (IMSI) of the mobile station MS.

On receipt of this message, the AAA server SA updates its memory or database with the information that it contains and then sends the gateway TTG identified in said message, via an interface called the Wm interface (arrow F18 in FIG. 2), a request for elimination of the end-to-end (VPN/IPSec) tunnel established between it and the mobile station MS. This request is of the “Tunnel Disconnection Command( )” type, for example.

On receipt of this request, the gateway TTG eliminates the identified VPN/IPSec tunnel and then sends the AAA server SA an acknowledgement message via the interface Wm (arrow F19 in FIG. 2).

On receipt of this acknowledgement message, the AAA server SA sends the home location request HLR an acknowledgement message via the interface Wm (arrow F20 in FIG. 2) to inform it that the VPN/IPSec tunnel has indeed been eliminated. This message is of the “Cancel Loc Ack( )” type, for example.

On receipt of this acknowledgement message, the home location register HLR sends the SGSN node S1 an acknowledgement message via the interface Gr (arrow 21 in FIG. 2) to inform it that the updates have indeed been effected. This message is of the “Update Location Ack( )” type, for example.

On receipt of this acknowledgement message, the SGSN node S1 sends the mobile station MS (which requested the transfer) a routing area update acceptance message via the interface Iu-PS (arrow F22 in FIG. 2), in order to inform it that it can now establish new tunnels to continue its service session via the 3GPP radio access network RAN. This message is of the “Routing Area Update Accept( )” type, for example.

On receipt of this message, the mobile station MS then establishes the new tunnel between itself and the SGSN node S1 (arrow F23 in FIG. 2), the other “new” tunnel (GTP) having been modified before this (change of end) in order to be established between the SGSN node S1 and the GGSN node NG (arrow F24 in FIG. 2).

Thanks to these two new tunnels (arrows F23 and F24) continuity of service is assured for the mobile station MS during transfer of the communication session from the WLAN network to the 3GPP mobile network.

The processor module MT of the proxy SGSN node S2 can be produced in the form of electronic circuits, software (electronic data processing) modules, or a combination of circuits and software.

The invention is particularly advantageous because it necessitates no modification or adaptation of the SGSN nodes and the GGSN nodes already installed in the 3GPP core network. The invention is not limited to the SGSN node, proxy SGSN node and management method embodiments described hereinabove by way of example only, but encompasses all variants that the person skilled in the art might envisage within the scope of the following claims.

1. Method for management of interworking between a wireless local area network and a mobile network, wherein, in case of reception by an SGSN node of said mobile network of a routing area updating report sent by a mobile station during an attempt to transfer from said wireless local area network to said mobile network a communication session relating to a service involving that mobile station and a tunnel termination gateway and a GGSN node of said mobile network, via end-to-end tunnels, the method comprises:
i) determining a communication identifier of a proxy SGSN node of said mobile network is determined from the routing area identifier contained in said request in order to send that proxy SGSN node a message requesting a transfer SGSN context of said mobile station,
ii) a communication identifier of said tunnel termination gateway is recovered from a home location register of said mobile network, by means of said proxy SGSN node, in order to send it a message requesting said transfer SGSN context of the mobile station, and
iii) in case of reception of said transfer SGSN context by said proxy SGSN node, that transfer SGSN context is determined to said SGSN node in order to effect a service PDP context updating procedure intended to eliminate and/or to modify said end-to-end tunnels established between said mobile station and said GGSN node, via said tunnel termination gateway, and to establish new tunnels between said mobile station and said GGSN node, via said SGSN node, to assure continuity of service during said communication session transfer.

2. Method according to claim 1, wherein in step iii) said SGSN node 3 sends said GGSN node a service PDP context update request and then sends said home location register a message reporting that it is being substituted for said tunnel termination gateway so that it instructs an AAA server of said mobile network to proceed to said elimination of the end-to-end tunnel between said mobile station and said tunnel termination gateway.

3. Method according to claim 2, wherein said SGSN node generates said substitution report message on receipt of a substitution confirmation message coming from said GGSN node.

4. Method according to claim 1, wherein said communication identifiers are IP addresses and/or ISDN identifiers.

5. Method according to claim 1, wherein in step iii) security operations are effected before effecting said service PDP context update procedure.

6. Method according to claim 1, wherein in step iii) a GTP type end-to-end tunnel is established between said GGSN node (and said SGSN node ( ).

7. SGSN node for a mobile communication network, wherein, in case of reception of a routing area updating report sent by a mobile station during an attempt to transfer from a wireless local area network to said mobile network a communication session relating to a service involving that mobile station and a tunnel termination gateway and a GGSN node of said mobile network via end-to-end tunnels, the SGSN node is configured to:
i) determine a communication identifier of a proxy SGSN node of said mobile network from the routing area identifier contained in said request,
ii) then send the proxy SGSN node a message requesting a transfer SGSN context of said mobile station, and
iii) in case of reception of said transfer SGSN context, initiate a service PDP context updating procedure intended to eliminate and/or to modify said end-to-end tunnels established between said mobile station and said GGSN node, via said tunnel termination gateway, and the establishing new tunnels between said mobile station and said GGSN node, via said SGSN node, to assure continuity of service during said communication session transfer.

8. SGSN node according to claim 7, wherein the SGSN node is configured to send said GGSN node a service PDP context update request, and then to send a home location register of said mobile network a message reporting that it is being substituted for said tunnel termination gateway, so that it instructs an AAA server of said mobile network to proceed to said elimination of end-to-end tunnels between said mobile station and said GGSN node, via said tunnel termination gateway.

9. SGSN node according to claim 8, wherein the SGSN node is configured to generate said substitution report message on receipt of a substitution confirmation message coming from said GGSN node.

10. SGSN node according to claim 7, wherein the SGSN node is configured to determine IP address and/or ISDN identifier type communication identifiers.

11. SGSN node according to claim 7, wherein the SGSN node is configured to effect security operations with said mobile station and said GGSN node before effecting said service PDP context update procedure.

12. SGSN node according to claim 7, wherein the SGSN node is configured to establish an end-to-end tunnel of GTP type with said GGSN node.

13. Proxy SGSN node for a mobile communication network, wherein the proxy SGSN node comprises a processor configured, in case of receipt, from an SGSN node according to claim 7, of a message requesting a transfer SGSN context of a mobile station, being transferred between a wireless local area network and said mobile network, of a communication session relating to a service,
i) to recover from a home location register of said mobile network a communication identifier of a tunnel termination gateway of said mobile network, involved in said session being transferred, and then
ii) on receipt of that communication identifier, to recover from said tunnel termination gateway said transfer SGSN context requested in order to transfer it to said SGSN node.

14. Proxy SGSN node according to claim 13, wherein said processor is configured to determine an IP address and/or ISDN identifier type communication identifier.
